(19) United States
(12) Patent Application Publication
(10) Pub. No.: US 2004/0037416 A1
(43) Pub. Date: Feb. 26, 2004

(54) Communication apparatus having one-way speakerphone function and a method of controlling the same

(75) Inventor: Cheol-Min Jeon, Suwon-city (KR)

Correspondence Address: STAAS & HALSEY LLP, SUITE 700, 1201 NEW YORK AVENUE, N.W., WASHINGTON, DC, 20005, US

(73) Assignee: SAMSUNG Electronics Co., Ltd., Suwon-city (KR)

(21) Appl. No.: 10/644,931

(22) Filed: Aug. 21, 2003

(30) Foreign Application Priority Data
Aug. 23, 2002 (KR) 2002-49960

(51) Int. Cl. H04M 9/00; H04M 1/00

(52) U.S. Cl. 379/388.02; 379/387.01

(57) ABSTRACT

A communication apparatus having a one-way speakerphone function including a handset connected to the communication apparatus by a transmit-receive line, wherein the transmit-receive line is enabled when the handset of the communication apparatus is off-hook; a speaker outputting a sound of the handset communication; an input key part including a selection key for the one-way speakerphone function and a plurality of dial keys; and a central control device controlling the one-way speakerphone function; wherein a conversation signal is transmitted through the speaker when the handset is off-hook, the one-way speakerphone function selection key signal is input, and it is determined that a dialing is completed.

### CROSS-REFERENCE TO RELATED APPLICATIONS

This application claims the benefit of Korean Application No. 2002-49960, filed Aug. 23, 2002, in the Korean Intellectual Property Office, the disclosure of which is incorporated herein by reference.

### BACKGROUND OF THE INVENTION

1. Field of the Invention

The present invention relates to a communication apparatus having a one-way speakerphone function and a method of controlling the same, and, more particularly, it relates to a communication apparatus having a one-way speakerphone function which is capable of preventing a howling phenomenon, caused by feedback, when performing the one-way speakerphone function, and a method of controlling the same.

2. Description of the Related Art

Communication apparatuses such as a telephone, a key-phone, a facsimile, and a Multi-Function Peripheral (MFP) are terminals for communicating data such as a voice, a document, and an image. These devices are used as office automation machines for transmitting or receiving the data using a public telephone network. The recently developed MFP integrates the functions of office automation machines such as a facsimile, a printer, a scanner, a photocopier, etc., into one body.

In this specification, the telephone, the facsimile, and the MFP are each referred to as a ‘communication apparatus’. Such a communication apparatus has a handset so that a user transmits/receives data using the handset. When the handset is taken off-hook by the user, a transmit-receive line is opened, enabling a sound transmission/reception. If the user mounts the handset back onto the hook of the communication apparatus body, the transmit-receive line is on-hook, blocking the sound transmission/reception.

Also, a user may use a speaker attached to the communication apparatus for a speakerphone function. The speakerphone function enables a user to speak with the other party through a speaker and a microphone attached the communication apparatus body without holding the handset. This speakerphone function also includes a one-way speakerphone function, in which the user uses the handset, rather than the microphone, with the speaker.

The one-way speakerphone function is to allow a third party around the user to hear the conversation between the user and the opposite party while the user is using the handset. When the one-way speakerphone function is selected, a speaker line is opened with the transmit-receive line of the handset being opened, so that a transmit-receive signal flowing through the handset is output through the speaker. However, since the transmit-receive signal output through the speaker is also returned to the handset, thus causing feedback, there occurs a howling problem.

### SUMMARY OF THE INVENTION

The present invention has been developed in order to solve the above and/or other problems in the prior art. Accordingly, an aspect of the present invention is to provide a communication apparatus having a one-way speakerphone function capable of preventing a howling phenomenon that occurs when a sound output from a speaker is input through a handset.

Additional aspects and advantages of the invention will be set forth in part in the description which follows and, in part, will be obvious from the description, or may be learned by practice of the invention.

The above and/or other aspects are achieved by providing a communication apparatus having a one-way speakerphone function comprising a handset connected to the communication apparatus by a transmit-receive line, wherein the transmit-receive line is enabled when the handset of the communication apparatus is off-hook; a speaker outputting a sound of the handset communication; an input key part comprising a selection key for the one-way speakerphone function and a plurality of dial keys; and a central control device controlling the one-way speakerphone function, wherein a conversation signal is transmitted through the speaker in response to the handset being off-hook, the one-way speakerphone function selection key signal being input, and a dialing being completed.

It is preferred, though not required, that when the dial key signal is not input within a predetermined time of the handset being off-hook and with the one-way speakerphone function selection key signal being input, the central control device switches to an on-hook dial mode in which a user dials with the handset being on-hook, and the conversation signal is output through the speaker.

Also, a method of controlling a communication apparatus having a one-way speakerphone function, comprises detecting whether a handset, which is connected to the communication apparatus through a transmit/receive line, is off-hook; detecting whether a signal of a one-way speakerphone function selection key included in an input key part of the communication apparatus is input; opening the transmit-receive line of the handset when detected that the handset is off-hook and the one-way speakerphone selection key signal is input; detecting whether a signal of a dial key in the input key part is input within a predetermined time; determining whether a dialing is completed; and upon determining that the dialing has been completed, opening a line connected to a speaker of the communication apparatus and performing a one-way speakerphone function to output a sound through the speaker during the handset conversation.

Also, the method of controlling a communication apparatus having a one-way speakerphone function, further comprises switching to an on-hook dial mode when the dial key signal is not input within the predetermined time, in which a user dials with the transmit-receive line of the handset being blocked and with the handset being on-hook, and then a conversation signal is output through the speaker.

Preferably, though not required, the dialing is determined to be completed when a next dial key signal is not input within a predetermined time after a current dial key signal is input.

### BRIEF DESCRIPTION OF THE DRAWINGS

These and/or other aspects and advantages of the invention will become apparent and more readily appreciated from the following description of the preferred embodiments, taken in conjunction with the accompanying drawings of which:

FIG. 1 is a block diagram showing a communication apparatus according to an embodiment of the present invention; and

FIG. 2 is a flowchart showing a method of controlling the communication apparatus of FIG. 1.

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to the like elements throughout. The embodiments are described below in order to explain the present invention by referring to the figures.

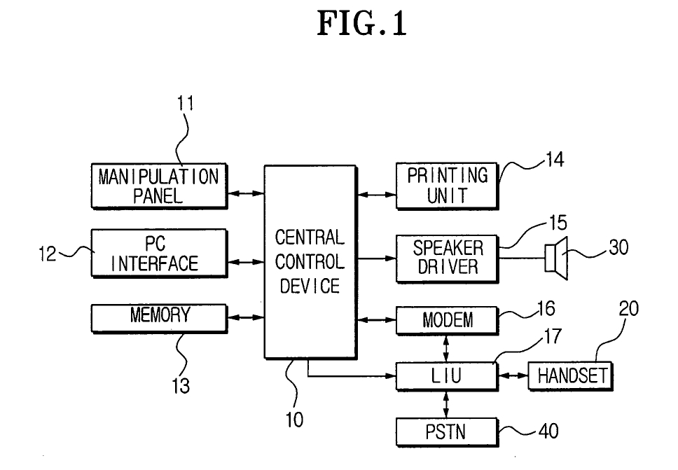

FIG. 1 is a block diagram showing a communication apparatus according to a preferred embodiment of the present invention. FIG. 1 shows a multi-function peripheral, which integrates various communication apparatuses, by way of an example.

Referring to FIG. 1, a communication apparatus includes a central control device 10, a manipulation panel 11, a PC interface 12, a memory 13, a printing unit 14, a speaker driver 15, a modem 16, a Line Interface Unit (LIU) 17, and a handset 20.

The central control device 10 controls the general operations of the communication apparatus according to information input from the outside and a stored program.

The manipulation panel 11 includes an input key part, having a one-way speakerphone function selection key and a dial key, and a display part for displaying the operation states of the communication apparatus. The manipulation panel 11 allows a user to both input a command and confirm the input command.

The memory 13 stores a program that is necessary for the operation of the communication apparatus, and various data that is used during the operation of the communication apparatus. The program includes the operations for performing the one-way speakerphone function of outputting a transmit-receive signal through a speaker when the handset 20 is off-hook, and a one-way speakerphone function key signal is input, and it is determined that a dialing is completed. In this embodiment, the memory 13 comprises a ROM and a DRAM.

The speaker driver 15 is connected to a speaker 30 for transmitting and outputting a dial tone and a voice signal through the speaker 30.

The modem 16 performs a coding and a decoding with respect to image data of the communication apparatus, and detects the dial tone. The LIU 17 interfaces a public network, which is called PSTN 40 hereinafter, and the modem 16 for the communication therebetween. The LIU 17 opens or blocks a transmit-receive line of the handset 20, under the control of the central control device 10, and allows the transmit-receive signal to be output through the speaker 30, according to the one-way speakerphone function selection key signal.

The handset 20 is mounted on a body of the communication apparatus, and includes a speaker part and a microphone part for allowing a user to communicate with another party. When the handset 20 is taken off-hook by the user, the transmit-receive line is opened so that the voice signal and the dial tone are transmitted/received. When the handset 20 is placed back on the body of the communication apparatus, thus returning it to on-hook, the transmit/receive line is blocked.

The PSTN 40 is a Public Switched Telephone Network. The PC interface 12 interfaces the communication apparatus and a PC to transmit information therebetween. The printing unit 14 prints data scanned according to a copying command, data transmitted to a facsimile, or data transmitted from the PC.

The communication apparatus according to the present invention includes a speakerphone function, a one-way speakerphone function, and an on-hook dialing function.

The speakerphone function allows a user to communicate with the opposite party through the speaker 30 and the microphone attached to the communication apparatus body without using the handset 20. The speakerphone function includes the one-way speakerphone function. The one-way speakerphone function allows a third party around the user to hear the conversation between the user and the opposite party while the user is using the hand set 20. When the one-way speakerphone function selection key signal is input, a speaker line is opened along with the transmit-receive line of the handset 20 being opened, so that a transmit/receive signal flowing through the handset 20 is also output through the speaker.

The on-hook dialing (OHD) function allows the user to dial another party with the handset 20 being on-hook. When the other party replies, the signal comes through the speaker 30, and the user is then able to use the handset 20 to communicate with the other party.

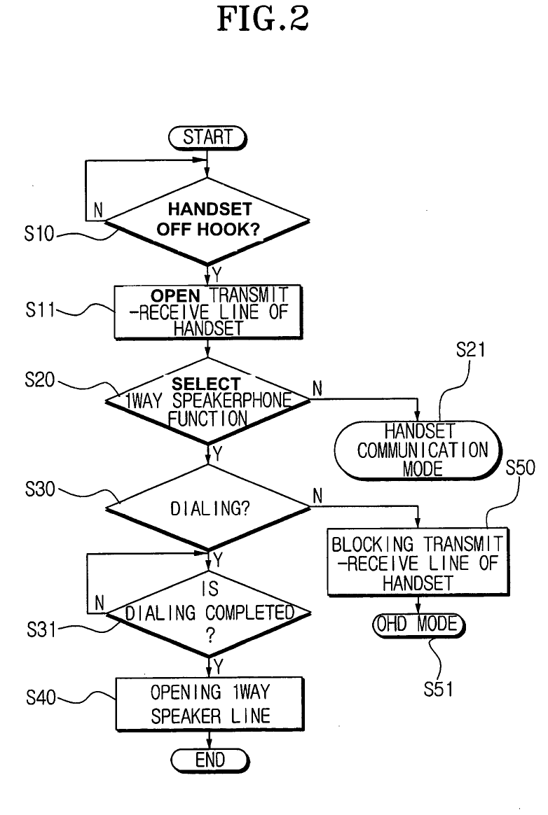

FIG. 2 is a flowchart showing a method of controlling the communication apparatus having the one-way speakerphone function according to an embodiment of the present invention.

When a user picks up the handset 20, thereby inputting an off-hook signal (S10), the central control device 10 controls the LIU 17 to open the transmit-receive line of the handset 20 (S11). Then, through the opened transmit-receive line of the handset 20, a voice signal and a dial tone are transmitted/received.

When it is detected that the hand-set 20 is off-hook, and the one-way speakerphone function selection key signal is input (S20), it is then determined whether or not a dial key signal is input by the user (S30). If the one-way speakerphone function selection key signal is not input within a predetermined time in S20, the communication apparatus is switched to a handset communication mode and performs a handset communication (S21).

When it is determined that the dial key signal is input within a predetermined time in S30, it is then determined whether or not dialing is completed. Dialing is determined to be completed when a next dial key signal is not input within a predetermined time after a current dial key signal is input. When it is determined that the dialing is completed, the speaker line is opened to perform the one-way speakerphone function of outputting the transmit-receive signal through the speaker. The speaker line is blocked until the dialing is completed, so that the dial tone is not output through the speaker.

If the dial key signal is not input within the predetermined time, the transmit/receive line of the hand set 20 is blocked and the communication device is switched to the on-hook dial mode, in which a user dials with the transmit-receive line of the handset 20 being blocked and then a conversation signal is output through the speaker.

Accordingly, during the performance of the one-way speakerphone function, the dial tone output from the speaker is not input to the handset 20.

The communication apparatus according to the present invention prevents a howling phenomenon by preventing the dial tone from being output through the speaker during the performance of the one-way speakerphone function.

The hardware included in the system may include memories, processors, and/or Application Specific Integrated Circuits (“ASICs”). Such memory may include a machine-readable medium on which is stored a set of instructions (i.e., software) embodying any one, or all, of the methodologies described herein. Software can reside, completely or at least partially, within this memory and/or within the processor and/or ASICs. For the purposes of this specification, the term “machine-readable medium” shall be taken to include any mechanism that provides (i.e., stores and/or transmits) information in a form readable by a machine (e.g., a computer). For example, a machine-readable medium includes read only memory (“ROM”), random access memory (“RAM”), magnetic disk storage media, optical storage media, flash memory devices, electrical, optical, acoustical, or other form of propagated signals (e.g., carrier waves, infrared signals, digital signals, etc.), etc.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A communication apparatus having a one-way speakerphone function comprising:
a handset connected to the communication apparatus by a transmit-receive line, wherein the transmit-receive line is enabled when the handset of the communication apparatus is off-hook;
a speaker outputting a sound of the handset communication;
an input key part comprising a selection key for the one-way speakerphone function and a plurality of dial keys; and
a central control device controlling the one-way speakerphone function;
wherein a conversation signal is transmitted through the speaker in response to the handset being off-hook, the one-way speakerphone function selection key signal being input, and dialing being completed.

2. The communication apparatus having a one-way speakerphone function of claim 1, wherein when the dial key signal is not input within a predetermined time of the handset being off-hook and with the one-way speakerphone function selection key signal being input, the central control device switches to an on-hook dial mode in which a user dials with the handset being on-hook, and the conversation signal is output through the speaker.

3. A method of controlling a communication apparatus having a one-way speakerphone function, the method comprising:
detecting whether a handset, which is connected to the communication apparatus through a transmit/receive line, is off-hook;
detecting whether a signal of a one-way speakerphone function selection key in an input key part of the communication apparatus is input;
opening the transmit-receive line of the handset when detected that the handset is off-hook and the one-way speakerphone selection key signal is input;
detecting whether a signal of a dial key in the input key part is input within a predetermined time;
determining whether a dialing is completed; and
upon determining that the dialing has been completed, opening a line connected to a speaker of the communication apparatus and performing a one-way speakerphone function to output a sound through the speaker during the handset conversation.

4. The method of controlling a communication apparatus having a one-way speakerphone function of claim 3, further comprising switching to an on-hook dial mode when the dial key signal is not input within the predetermined time, in which a user dials with the transmit-receive line of the handset being blocked and with the handset being on-hook, and then a conversation signal is output through the speaker.

5. The method of controlling a communication apparatus having a one-way speakerphone function of claim 3, wherein the dialing is determined to be completed when a next dial key signal is not input within a predetermined time after a current dial key signal is input.

6. A communication apparatus having a one-way speakerphone function comprising:
a handset connected to the communication apparatus by a transmit-receive line;
a speaker; and
a control device controlling the one-way speakerphone function;
wherein a signal is not transmitted through the speaker until a dialing has been completed.

7. The communication apparatus of claim 6, wherein the transmit-receive line is enabled when the handset is off-hook.

8. The communication apparatus of claim 7, further comprising an input key part comprising a selection key for the one-way speakerphone function and a plurality of dial keys.

9. The communication apparatus of claim 8, wherein a conversation signal is transmitted through the speaker when the handset is off-hook and the one-way speakerphone function key is selected.

10. The communication apparatus of claim 8, wherein the control device switches to an on-hook dial mode when the one-way speakerphone function key is selected and a dial key signal is not input within a predetermined time of the handset being off-hook.

11. The communication apparatus of claim 10, wherein the conversation signal is output through the speaker, with the handset being on-hook, when operating in the on-hook dial mode.

12. The communication apparatus of claim 6, wherein a line interface unit opens or blocks the transmit-receive line of the handset, and allows a transmit-receive signal to be output through the speaker, under control of the control device.

13. The communication apparatus of claim 6, further comprising a personal computer interface coupling a personal computer to the control device.

14. The communication apparatus of claim 13, wherein the personal computer interface interfaces the communication apparatus and the personal computer to transmit information therebetween.

15. The communication apparatus of claim 6, further comprising a memory device that stores user data and a program for the control device.

16. The communication apparatus of claim 15, wherein the memory device comprises a ROM and a DRAM.

17. A method of controlling a communication apparatus having a one-way speakerphone function, the method comprising:
opening a transmit-receive line of a handset connected to the communication apparatus when the handset is taken off-hook;
determining whether a one-way speakerphone mode has been selected; and
upon determining that a dialing has been completed, opening a line connected to a speaker of the communication apparatus and performing the one-way speakerphone function to output a sound through the speaker during the handset conversation.

18. The method of controlling a communication apparatus having a one-way speakerphone function of claim 17, wherein the dialing is determined to be completed when a next dial key signal is not input within a predetermined time after a current dial key signal is input.

19. The method of controlling a communication apparatus having a one-way speakerphone function of claim 17, further comprising switching to an on-hook dialing mode when a dial key signal is not input within a predetermined time after the handset is taken off-hook and the one-way speakerphone mode has been selected.

20. The method of controlling a communication apparatus having a one-way speakerphone function of claim 19, wherein the on-hook dialing mode allows a user to communicate with another party through the speaker while the handset is on-hook.

21. A machine-readable storage storing information enabling a device to perform a process of controlling a communication apparatus, the process comprising:
opening a transmit-receive line of a handset connected to the communication apparatus when the handset is taken off-hook;
determining whether a one-way speakerphone mode has been selected; and
upon determining that a dialing has been completed, opening a line connected to a speaker of the communication apparatus and performing the one-way speakerphone function to output a sound through the speaker during the handset conversation.
